(19) United States
(12) Patent Application Publication
(10) Pub. No.: US 2022/0379346 A1
(43) Pub. Date: Dec. 1, 2022

(54) ULTRASONIC TRANSDUCERS

(71) Applicant: SINTEF TTO AS, Trondheim (NO)

(72) Inventors: Frode TYHOLDT, Trondheim (NO); Andreas VOGL, Trondheim (NO); Tobias DAHL, Trondheim (NO)

(21) Appl. No.: 17/770,872

(22) PCT Filed: Oct. 26, 2020
(86) PCT No.: PCT/GB2020/052712

§ 371 Date: Apr. 21, 2022

(30) Foreign Application Priority Data
Oct. 25, 2019 (GB) 1915544.9

(51) Int. Cl. B06B 1/06; G01S 15/89; G01S 7/521; G01S 7/527

(52) U.S. Cl. CPC B06B 1/0622; G01S 15/8913; G01S 15/8925; G01S 7/521; G01S 7/527; G01S 7/52004

(57) ABSTRACT

A piezoelectric micro-machined ultrasonic transducer (PMUT) is provided, comprising a dedicated ultrasonic transmitter and at least one separate dedicated ultrasonic receiver on a single common semiconductor die. A plurality of PMUTs may be arranged in a tessellated array. Also disclosed is a system comprising at least one PMUT on a single common semiconductor die, a dedicated ultrasonic transmitter arranged to transmit a first ultrasonic signal and at least one separate dedicated ultrasonic receiver arranged to receive a second ultrasonic signal is also provided. The system further comprises a signal processing subsystem which comprises an analogue domain; a digital domain; a digital to analogue converter; and an analogue to digital converter. The signal processing subsystem is arranged to generate an estimated direct path signal in said digital domain, convert said estimated direct path signal to an analogue estimated direct path signal using said digital to analogue converter, subtract said analogue estimated direct path signal from said second signal to produce a modified received signal and convert said modified received signal to a digital modified received signal using said analogue to digital converter.

This invention relates to ultrasonic transducers—that is to devices for generating and receiving sound waves with frequencies higher than those audible to humans. They can be used in many applications from simple ranging applications where the distances to objects can be estimated by measuring the time between transmitting an ultrasound signal and receiving a reflected echo signal, to complex medical imaging applications.

In many applications it is important to make transducers as small as possible—either because they are to be fitted into a small device or to allow large arrays to be used. One technology that has been developed for this purpose is that of piezoelectric micro-machined ultrasonic transducers (PMUTs) where each PMUT element typically acts as both a transmitter and receiver when coupled to appropriate circuitry.

Although PMUTs achieve the objective of producing small ultrasound transducers, the Applicant has appreciated that there are shortcomings associated with them.

When viewed from a first aspect the present invention provides a piezoelectric micro-machined ultrasonic transducer (PMUT) comprising a dedicated ultrasonic transmitter and at least one separate dedicated ultrasonic receiver on a single common semiconductor die.

The invention extends to a system for transmitting and receiving ultrasonic signals comprising at least one PMUT as described herein, a transmitter circuit arranged to drive said ultrasonic transmitter and a receiver circuit arranged to detect signals from said ultrasonic receiver.

Thus it will be seen by those skilled in the art that in accordance with the invention, a single die has a separate dedicated transmitter and receiver. This addresses one of the shortcomings with the prior art approach identified by the Applicant in that if the same element acts as both transmitter and receiver, then signals need to be transmitted in a burst mode which are typically very short, sharp, and high power. Short bursts are required so that the element acting as both a transmitter and receiver is able to switch from transmission to reception to capture reflected signals from nearby objects. The bursts have to be of relatively high power to ensure that adequate energy is transmitted to provide adequate resolution. This means that associated electronics required to switch between the element acting as a transmitter and that these electronics are complex due to the need to cope with the high power output of the burst transmission.

By contrast in accordance with the invention, having both a dedicated transmitter and dedicated receiver(s) on a single semiconductor die allows for simultaneous transmission and receiving of signals and therefore no switching electronics are required. This may reduce the complexity of the system electronics. Moreover a given transmission energy can be achieved by a longer, lower power transmission which reduces the demands on the transmitter itself and driving circuitry as there is no need to create the power electronics required for burst transmission. Also, it means that a ‘blanking period’ can often be avoided at the receiver, i.e. the time-window during which the receiver is ‘shut down’ because it acts as a transmitter at the time. This in turn means that with traditional switching systems, it is difficult to measure distances to objects which are very close to the sensor/transmitter setup. When a longer, lower-power transmission is used, the receiver can ‘listen’ while transmission is on-going, and pick up superpositions of echoes and direct-path sound between transmitter and receivers. This can in turn enable detection and imaging of nearby objects.

For example, on a 100 kHz system, there may be 100 signals such as e.g. chirps sent every second. Each of those chirps may span the full period, i.e. up to 1/100th of a second or 10 ms. However, it may also be shorter, but to create any meaningful codes—i.e. not just a spike or burst, it is anticipated that it must fill at least 1/100th of this period, or 0.1 ms. Using, say, a 200 kHz sampling frequency this amounts to 200,000*0.0001 seconds or 20 samples. A code which is shorter than 20 samples will be more similar to a burst than a useful actual coded signal such as a chirp. The code could also and preferably be longer than 20 samples, i.e. 50 samples or 100 samples or it could be even longer should the application require less high-speed tracking. For a motion tracking system dealing mostly with slowly moving objects, a frame rate of 30 Hz may be sufficient, meaning that 300 ms is a good chirp length.

In a set of embodiments, a direct path signal is subtracted from the received signal to produce a modified received signal. The direct path signal is the signal which travels directly from the ultrasonic transmitter to the ultrasonic receiver, without having been reflected off an object of interest. The direct path signal could comprise in-air direct acoustic path signals, and/or signals transmitted directly from the transmitter to the receiver through the semiconductor die. Subtraction of the direct path signal can be carried out on the digital received signal, once it has undergone analogue-to-digital conversion, e.g. using a suitable digital signal processor. However the Applicant has appreciated a shortcoming with this approach. Typically, the direct path signal is much stronger than the desired received reflection signal from an object of interest. As such, when received signals from an ultrasonic receiver undergo analogue-to-digital conversion by an analogue-to digital (A/D) converter, the A/D converter requires a high dynamic range in order to convert both the desired received signal, i.e. reflections from an object of interest, as well as the much stronger direct path signal. A high dynamic range A/D converter, i.e. one with sufficient bit resolution to avoid saturation, is more complex, and therefore more costly and uses more power, thereby making it undesirable.

Therefore, in a set of embodiments, the direct path signal is subtracted from the analogue received signal prior to conversion to digital to produce a modified received signal. This may then be converted to a digital modified received signal. As the modified received signal does not include the direct path signal, the A/D converter may therefore not require such a high dynamic range, and as such may be relatively simple and inexpensive.

In a set of such embodiments the dedicated ultrasonic transmitter is arranged to transmit a first ultrasonic signal and the dedicated ultrasonic receiver is arranged to receive a second ultrasonic signal, the system further comprising a signal processing subsystem comprising:

an analogue domain;

a digital domain;

a digital to analogue converter; and

an analogue to digital converter,

wherein the signal processing subsystem is arranged to generate an estimated direct path signal in said digital domain, convert said estimated direct path signal to an analogue estimated direct path signal using said digital to analogue converter, subtract said analogue estimated direct path signal from said second signal to produce a modified received signal and convert said modified received signal to a digital modified received signal using said analogue to digital converter.

Such an arrangement is novel and inventive in its own right. Therefore, when viewed from a further aspect, the invention provides a system comprising at least one piezoelectric micro-machine ultrasonic transducer (PMUT), the PMUT comprising, on a single common semiconductor die, a dedicated ultrasonic transmitter arranged to transmit a first ultrasonic signal and at least one separate dedicated ultrasonic receiver arranged to receive a second ultrasonic signal, the system further comprising a signal processing subsystem comprising:

an analogue domain;

a digital domain;

a digital to analogue converter; and

an analogue to digital converter,

wherein the signal processing subsystem is arranged to generate an estimated direct path signal in said digital domain, convert said estimated direct path signal to an analogue estimated direct path signal using said digital to analogue converter, subtract said analogue estimated direct path signal from said second signal to produce a modified received signal and convert said modified received signal to a digital modified received signal using said analogue to digital converter.

Thus it will be seen that in accordance with the aforementioned embodiments and aspect of the invention, an estimate of the direct path signal can be calculated in the digital domain but subtracted in the analogue domain in order to limit the dynamic range required for the A/D converter as previously explained.

In a set of embodiments, the direct path signal from the transmitter to the receiver is recorded to create a database of direct path signals e.g. in the digital domain. This could be done e.g. by time-gating received signals to exclude reflections from the environment. The direct path signals may be recorded over a period of time in order to create a more reliable database of direct path signal measurements. Additionally or alternatively the direct path signals may be recorded under different environmental conditions, such as at varying temperatures. In a set of embodiments, the estimated direct path signal is chosen from the database. The estimated signal could be a random guess, or may be chosen depending on an input from an environmental sensor such as a temperature sensor used in the direct path signal database creation.

In a set of embodiments, a quality parameter of the digital modified received signal is monitored. This may indicate whether the estimated direct path signal for subtraction from the received signal was a good selection. An example of a quality parameter is minimum energy, which can indicate the extent to which the strongest component, the direct path, has been removed from the received signal. Another parameter which may be used to monitor the quality is sparsity, with maximum sparsity of the signal indicating a “clear echo” is being received.

In a set of embodiments, the estimated direct path signal is modified if the quality parameter is above a first threshold. For example a filter may apply a convolution to the direct path estimation.

In a set of embodiments, new direct path signals from the ultrasonic transmitter to the ultrasonic receiver are recorded to create a new database of direct path signals if the quality parameter is below a second threshold. Very poor quality may indicate a substantial change in the behaviour or surroundings of the transmitter. In a set of embodiments, a new estimated direct path signal is chosen from the database if the quality parameter is above the second threshold, but below the first threshold.

In a set of embodiments therefore the system monitors a quality parameter of the digital modified received signal and, based on the quality parameter, carries out one of: using the estimated direct path signal; modifying the estimated direct path signal; choosing a new estimated direct path signal from the database; or recording one or more new direct path signals from the ultrasonic transmitter to the ultrasonic receiver.

Therefore, the received signal may be used for further analysis such as proximity, presence or gesture sensing if the quality parameter is above the first threshold and the estimated direct path signal for subtraction from the received signal was a good selection.

In a set of embodiments of any aspect of the invention, the PMUT comprises one or more acoustic path barriers arranged between the ultrasonic transmitter and the ultrasonic receiver. These acoustic path barriers may act to physically reduce the strength of the in-air direct acoustic path signal by impairing air transmission of the signal between the transmitter and the receiver elements.

When viewed from another aspect the invention provides a method of operating a system for transmitting and receiving ultrasonic signals comprising at least one PMUT as described herein, the method comprising transmitting signals from said ultrasonic transmitter and receiving signals using said ultrasonic receiver at the same time for at least part of a period of operation.

When viewed from a further aspect the invention provides a method of operating a system for transmitting and receiving ultrasonic signals comprising at least one PMUT as described herein, the method comprising periodically transmitting signals from said ultrasonic transmitter wherein each transmission period is longer than 0.1 millisecond, e.g. longer than 0.2 milliseconds.

In a set of embodiments a coded transmission is used. This can allow receivers to distinguish the time at which portions of the signal was transmitted and therefore calculate the distance travelled by the reflected signal from an object. One simple example of a coded transmission is a chirp—e.g. a continuously increasing/decreasing frequency transmission. Received signals at a particular frequency then give information about when the signal was originally transmitted, and the distance travelled by the signal can be calculated.

The system impulse response may be computed from the received chirp signal, by correlating the transmitted signal with the received signal, or more advanced techniques for impulse response estimation could be used, such as deconvolution. Specifically, if the transmit signal is s(t), then the received signal will be:

y(t)=h(t)*s(t)+n(t)

where h(t) is the channel impulse response, and n(t) is a noise term. Then, assuming the transmit signal to be approximately white, i.e. s(t)*s(−t)≈∂(t), where ∂(t) is an approximate dirac pulse, one can obtain an estimate of the impulse response as:

[symbol]

=y(t)*s(−t)=h(t)*s(t)*s(−t)+n(t)*s(−t)≈h(t)+n₂(t)

where n₂(t)=s(−t)*n(t).

One can also or alternatively compute an impulse response by deconvolution, i.e. by constructing a matrix S from samples of the signal s(t), to obtain a matrix-vector equation set:

y=Sh+n

where the vector y contains stacked samples of the time-series y(t), and h stacked samples of the impulse response h(t), and then compute h as the solution to this equation set under any suitable norm or constraint. The impulse response contains information both about direct path signals and echoes than can be disambiguated using known DSP techniques.

Although counter-intuitive to those skilled in the art in view of the differing processes typically needed to fabricate transmitters and receivers, the Applicant has recognised the advantage of having these different dedicated elements on a single common die or chip, in that it allows more elements in a smaller area, and the size of any arrays of multiples dies can thus be reduced. This has beneficial in many fields but in particular in the fields of smart wearables, for example, where high resolution is required in a smaller area.

The die could be of any convenient shape but in a set of embodiments the die is square or rectangular. The transmitter may be of any shape but is preferably circular. Similarly the or each receiver is preferably circular.

The layout of the transmitter and receiver(s) on the die can be implemented in any convenient way. In a set of embodiments the ultrasonic transmitter is located substantially at the centre of the die and the ultrasonic receiver(s) is/are located substantially in a corner or in respective corners of the die. In one example where the die is square or rectangular, one ultrasonic receiver is provided in each of the corners of said die—i.e. there are four receivers.

In a set of embodiments the ultrasonic transmitter or system is configured to transmit signals having a main wavelength (λ) and said semiconductor die has a width substantially equal to half of said main wavelength (λ/2). Similarly the invention extends to a method of operating a system for transmitting and receiving ultrasonic signals comprising at least one PMUT as described herein, the method comprising transmitting signals from said ultrasonic transmitter having a main wavelength which is substantially twice a width of said semiconductor die.

Having the die of width λ/2 may be beneficial when a plurality of dies of the kind described herein are arranged in a tessellated array since the transmitters thereof will thus be spaced substantially by λ/2. As will be appreciated by those skilled in the art or array signal processing, this is the optimum for carrying out beamforming and the like. Where, as set out above, the receivers are in the corners of the dies, corresponding receivers on respective dies will also be spaced apart substantially by λ/2. Where there are receivers in each corner, these will form 2×2 mini arrays spanning each vertex of the tiled dies, and each of these mini arrays will have a λ/2 spacing from the other such mini arrays. This arrangement can be shown theoretically to give a high degree of resolution and beam steering capabilities because it doesn't breach the spatial Nyqvist sampling criterion, which would have caused so-called grating lobes. The mini arrays can be used as ‘one common sensor’, i.e. by summing or averaging the signals coming from them, or alternatively, their inputs can be used individually, as input to an array processing method that treats each of the elements individually. This has certain benefits, such as the ability to better focus in on, or cancel out, sounds coming from specific directions. As an example, if there is a signal coming into the broadside of the array, then the signals s1(t), s2(t), s3(t), s4(t) can be combined to become for example s1(t)−s2(t)+s3(t)−s4(t), or also s1(t)+s2(t)−s3(t)−s4(t), both of which will have 0 response in the forwards direction, but not from other directions.

The invention extends to an arrangement comprising a plurality of PMUTs as described herein arranged in a tessellated, preferably rectangular array.

The sizes of the transmitter and receiver can be selected to suit the particular application. In a set of embodiments the transmitter is larger than the receiver(s). This may be beneficial in generating the required transmission energy efficiently. In a set of embodiments the ultrasonic transmitter has a width that is at least twice as large as a width of the ultrasonic receiver. It may for example be at least three, four, five or more times larger than the receiver(s). The Applicant has appreciated that a particularly beneficial arrangement is to have a larger transmitter in a circular transmitter centrally on a square die and circular receivers in the edges thereof. Such a geometry allows for a compact overall die size whilst allowing the size of the transmitter to be maximised.

In a set of embodiments a plurality of dies are provided on a flexible substrate. As each die is equipped with both transmitter and receiver elements, the dies can be arranged to compute each other's relative positions. The dies could thus be mounted on flex-PCB which can then be attached onto any of a number of different surfaces. This can make for a flexible, low power, supermountable 3D imaging systems for microbots, drones etc. Multiple dies can also be used to build self-configurable arrays or sensor networks. These can be made self-configurable by exploiting the fact that, since each die has at least both a transmitter and a receiver, the relative positions of each element can be worked out by using time-of-flight measurements, or directional measurements (direction of arrival) or relative time-differences (time difference of arrival) or combinations of those, between a transmitter and receiver pair not on the same die, in combination with knowledge of the die layout(s).

Such an arrangement is novel and inventive in its own right and thus when viewed from a further aspect the invention provides a method of operating a system for transmitting and receiving ultrasonic signals comprising a non-planar array of piezoelectric micro-machined ultrasonic transducers (PMUTs), each comprising a dedicated ultrasonic transmitter and at least one separate dedicated ultrasonic receiver on a single common semiconductor die, the method comprising transmitting one or more signals from the transmitter of at a first one of said PMUTs in said non-planar array, receiving said signal(s) using at least one receiver of a second one of said PMUTs of said non-planar array and using said received signals to determine a mutual relative position of said first and second PMUTs.

This aspect of the invention extends to a system configured to carry out the aforementioned method.

In a set of embodiments the mutual relative position is used in subsequent signal processing of signals received by one or more receivers on said first and second PMUTs.

The PMUT may be formed from any suitable piezoelectric material but in a set of embodiments the ultrasonic transmitter and/or the ultrasonic receiver are fabricated from aluminium nitride or aluminium-scandium nitride. As mentioned above, although it would conventionally have been seen as difficult to fabricate transmitters and receivers on a common die, the Applicant has appreciated that using these materials for both the transmitter and receiver facilitates this without unduly compromising the performance of either. The Applicant has found for example that a transmitter fabricated of AIN can in some circumstances be driven with a greater voltage than vapour deposited lead zirconate titanate (PZT) and further that substituting scandium for some of the aluminium may significantly enhance the performance of the PMUT. Both the transmitter and receiver can be made of the same material or it is also possible to use a combination of materials that are optimized for either highly effective transmitting and receiving.

In other embodiments the ultrasonic transmitter and/or the ultrasonic receiver are fabricated from PZT (lead-zirconate-titanate), KNN ((K,Na)NbO3), ZnO (zinc oxide), BaTiO3 (Barium titanate) or PMN-PT (Pb(Mg⅓Nb⅔)O3—PbTiO3).

In a set of embodiments, the transmitter and receiver are fabricated from different materials. For example, the ultrasonic transmitter may be fabricated from PZT, and the ultrasonic receiver may be fabricated from AlN. PZT typically outputs higher sound pressure at lower voltages than AlN.

In practice, if AlN is used for the transmitter, it may be difficult to build a PMUT system which provides a sufficiently strong output signal without building a complex and expensive amplification output circuit. For example, in a room monitoring application where an ultrasound system is mounted in the ceiling of a large room, there may be insufficient energy transmitted towards the lower levels of the floor to get a useful echo back if AlN is used for the transmitter instead of PZT. As such, it may be desirable to use PZT to fabricate the ultrasonic transmitter.

Once the transmitted signals have been generated so as to provide a sufficiently strong echo received from the surroundings, it is desirable to receive the echoes with as high a signal-to-noise ratio (SNR) as possible. AlN has a higher sensitivity than PZT to ultrasonic signals, and as such is better suited to this purpose. A better SNR leads to better ultrasound detection, and better effective beamforming in array beamforming applications. In addition to this, a sufficiently sensitive ultrasonic receiver with a good SNR drives down the need for excessive output power (i.e. there is less need for a strong signal to improve the SNR) and use excessive power in the device. For instance, in room monitoring applications, a device using a PMUT may be battery powered, and unnecessarily high power output levels would reduce the battery life.

Although PZT, when used to fabricate the ultrasonic transmitter, provides a higher sound pressure than AlN, there may also be drawbacks with using PZT for the ultrasonic transmitter, and AlN for the ultrasonic receiver. For PZT to have a high sensitivity, the material must be polarised prior to use in order to cause PZT to display piezoelectric properties. However, in a high volume fabrication scenario, the additional step of polarisation of the material may result in more costly and complex manufacturing.

Therefore, in a set of embodiments, the transmitter and receiver are fabricated from the same material. This may increase the ease of manufacturing, particularly if AlN is used in both the ultrasonic transmitter and ultrasonic receiver, as there may be no polarisation of the material required.

In a set of embodiments, the ultrasonic receiver is an optical receiver. When the ultrasonic transmitter and ultrasonic receiver are made from different materials, optical receivers may be used in combination with another type of transmitter. Two suitable exemplary types of optical receivers are those which use optical multiphase readout, and optical resonators. Optical multiphase readout is described for example in WO 2014/202753, and optical resonators are described for example in Shnaiderman, R. et al., “A submicrometre silicon-on-insulator resonator for ultrasound detection”, Nature, 2020, 585, 372-378.

Both these optical receiver approaches may improve the SNR of the received signals. This may enable the optical receiver elements to be much closer to one another than the typical λ/2 spacing which is used between receiver elements, with high resolution imaging being achieved in accordance with the super directivity principle. As such, through use of multiple, closely spaced optical receivers on a single die with a suitable transmitter, a compact ultrasound imaging component may be fabricated.

Certain embodiments of the invention will now be described, by way of example only, with reference to the accompanying drawings in which:

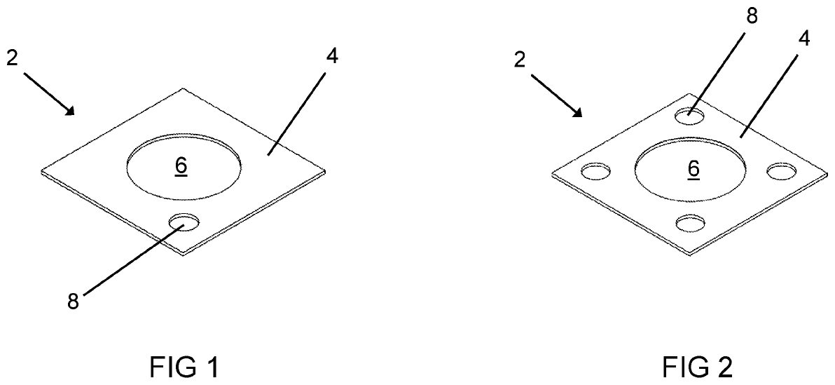

FIG. 1 is a view of a PMUT in accordance with a first embodiment of the invention;

FIG. 2 is a view of a PMUT in accordance with a second embodiment of the invention;

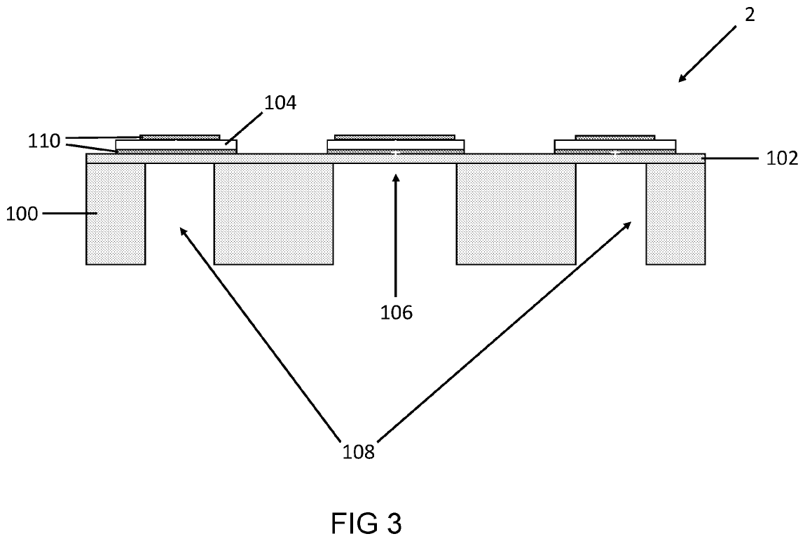

FIG. 3 is a cross-section of the PMUT of FIG. 1;

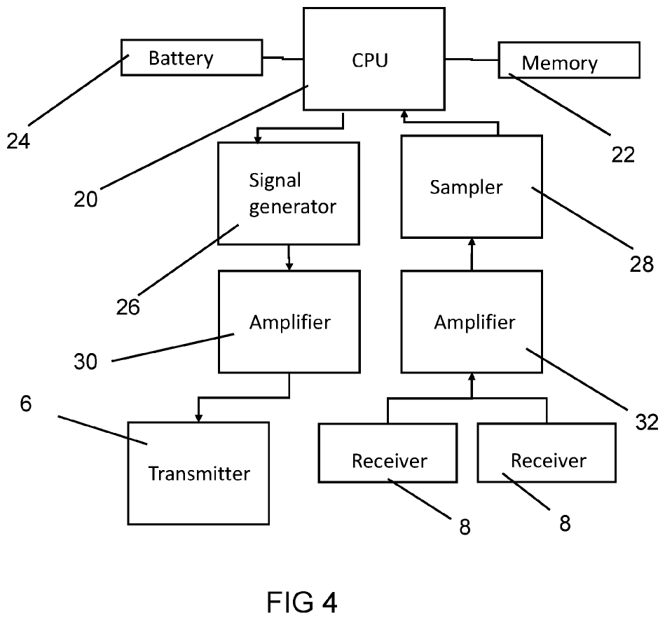

FIG. 4 is a block diagram of a system for transmitting and receiving ultrasonic signals;

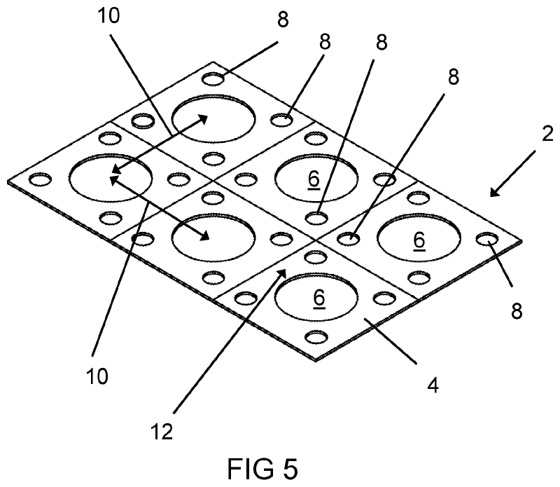

FIG. 5 is a view of a rectangular array of the PMUTs as shown in FIG. 2;

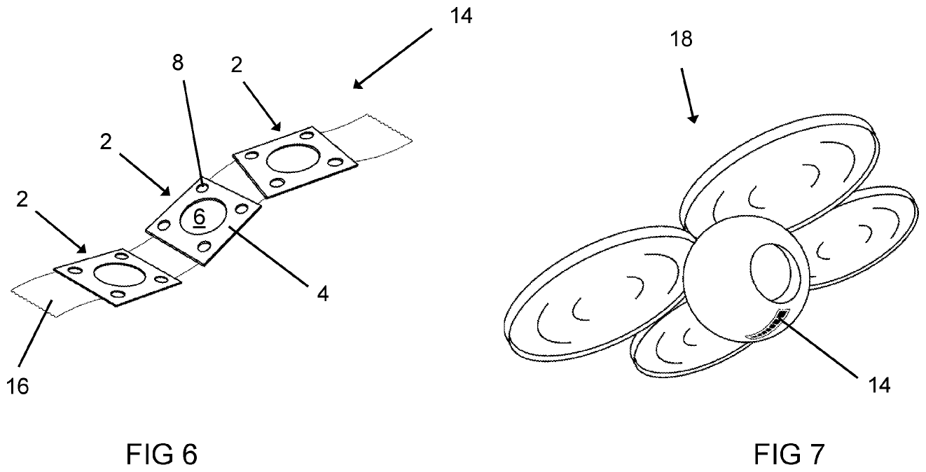

FIG. 6 is a view of an array of the PMUTs as shown in FIG. 2 attached to a flexible substrate;

FIG. 7 is a view of an unmanned aerial vehicle with the array of FIG. 6 attached thereto;

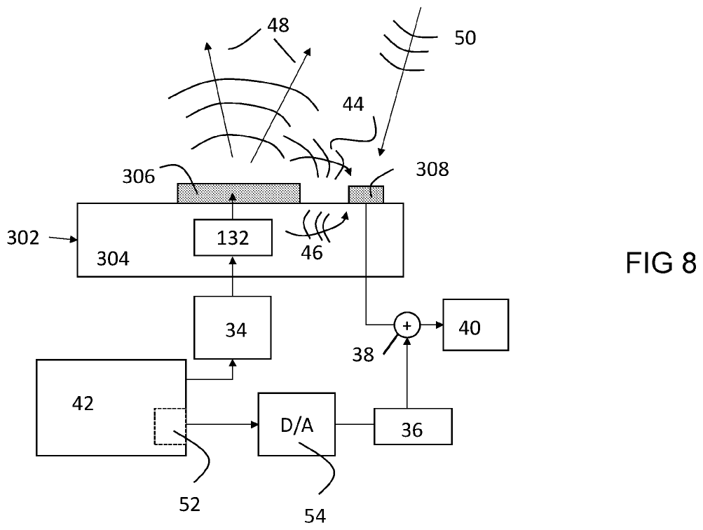

FIG. 8 is a schematic diagram of a PMUT and associated system for reducing direct path signals;

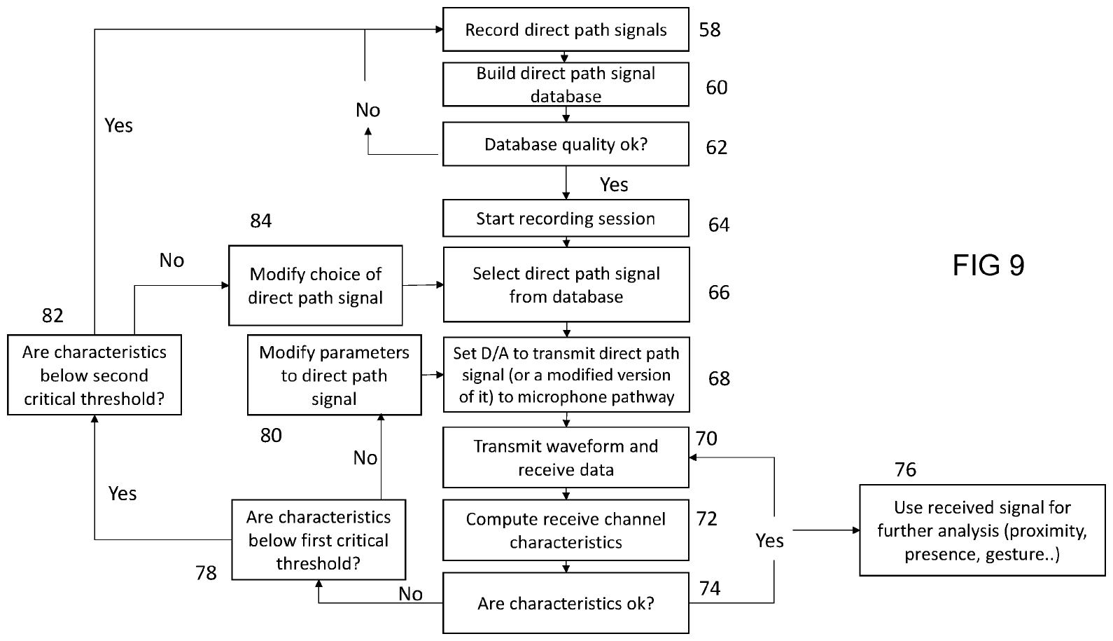

FIG. 9 is a flowchart illustrating a method of generating an estimate of the direct path signals of the system shown in FIGS. 8 and 9;

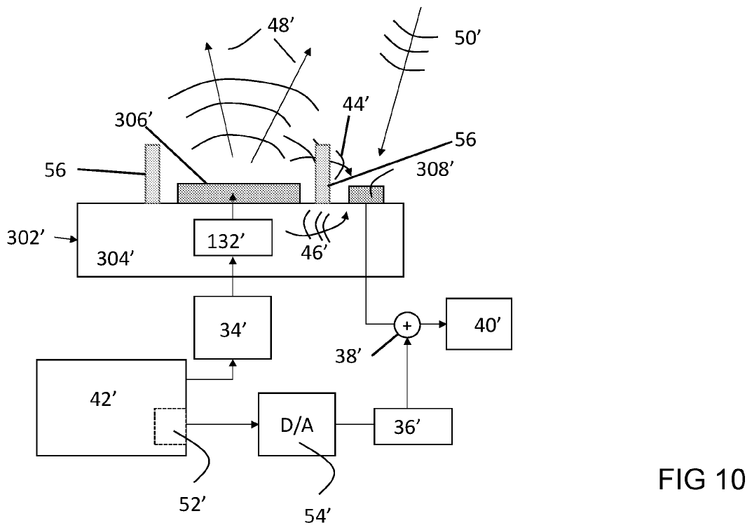

FIG. 10 is a further schematic diagram of a PMUT and associated system for reducing direct path signals; and

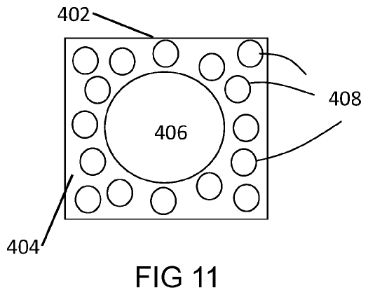

FIG. 11 is a view of a PMUT using optical receivers.

FIG. 1 is a simplified view of a piezoelectric micro-machined ultrasonic transducer (PMUT) 2 in accordance with an embodiment of the invention. The PMUT 2 comprises a square silicon die 4 onto which an ultrasonic transmitter 6 and an ultrasonic receiver 8 are formed. Further details of the fabrication process are given below and with reference to FIG. 3.

As will be seen, the transmitter 6 is circular and located in the centre of the die. The receiver 6 is much smaller than the transmitter 6 and is located in the unused space in one corner of the die. FIG. 2 shows a variant embodiment in which respective receivers 8 are located in each corner of the die 4. Of course other numbers of receivers could be provided—e.g. two, three or more. They could also be located elsewhere or more than one could be located in a given corner. The transmitter could be differently shaped or located and/or multiple transmitters could be provided.

The transmitter 6 might be designed, for example, to transmit signals at a frequency of 40 kHz or higher. The die 4 has a width of approximately 4 mm which is half of the wavelength of these signals in air. The transmitter 6 has a diameter of approximately 3 mm whereas the receiver(s) has a diameter of approximately 0.1 mm.

FIG. 3 is a schematic diagonal cross-section which shows in more detail the layers of the PMUT 2 shown in FIG. 2. This comprises a silicon substrate 100 having an aperture 106 at its centre corresponding to the transmitter and smaller apertures 108 in the corners corresponding to the receivers. Laid on the silicon substrate 100 is a silicon membrane 102.

Above the transmitter and receiver apertures 106, 108 are respective piezoelectric stacks comprising a piezoelectric thin film material layer 104—e.g. of AlN, AlScN or PZT—sandwiched between two electrodes 110.

The device can be fabricated by using typical microfabrication technologies. The structures for the transmitters and microphones can be typically thin membranes, (one or two dimensional) cantilever structures or bridges. The main part of these mechanical structures typically comprises silicon. These structures can be manufactured by e.g. silicon bulk micromachining—i.e. removal of a major part of the silicon when starting with a silicon wafer, which leaves the intended mechanical (thin) structure or silicon surface micromachining—i.e. depositing a (structured) sacrificial layer and a silicon thin film leaving the mechanical structure after structuring the silicon film and removing the sacrificial layer.

Besides the main mechanical part of the transmitter or microphone elements, these elements include thin film metal electrodes and the piezoelectric thin film. This might be the same piezoelectric thin film material for the transmitter and microphone part of the device or different piezoelectric thin film materials with optimized properties for transmitting and sensing. The thin-film electrode materials and piezoelectric thin film material(s) are typically structured prior to the structuring of the silicon part of the mechanical structure. Depending on the actuation and read-out concept either two electrodes—one layer below and one on the top of the piezoelectric layer using the 31-mode—or one electrode—on top of the piezoelectric layer using the 33-mode—can be used.

The electrode materials are typically deposited by a sputtering process. The piezoelectric thin-film materials can—dependent on the material—also be deposited by physical methods such as sputtering or with a pulsed-laser deposition process or using chemical methods such as chemical vapor deposition (CVD) or chemical solution deposition (CSD).

FIG. 4 shows a highly simplified schematic block diagram of the typical components of an ultrasound transmission and reception system using the PMUTs 6, 8 described herein. The system includes a CPU 20 having a memory 22 and a battery 24 which will typically power all components of the system. The CPU 20 is connected to a signal generator 26 and a signal sampler 28. These could be provided in practice by a suitable digital signal processor (DSP). The signal generator 26 is connected to a transmit amplifier 30 which drives the ultrasonic transmitter 6.

On the other side the receivers 8 are connected to a receive amplifier 32 which passes signals to the sampler 28 and onto the CPU. It will be noted that because the transmitter 6 is separate from the receivers 8 and the path for driving it is independent of the path for receiving signals, there is no need for complicated switching electronics and transmission and reception can be carried out simultaneously.

In use the transmitter 6 can be driven with relatively long, low power signals—e.g. more than 0.1 or 0.2 milliseconds long rather than needing to be driven with a sharp burst signal.

FIG. 5 shows a rectangular array of PMUTs 2 of the type shown in FIG. 2. Here it will be seen that the individual dies 4 are tessellated together in a mutually abutting relationship on a common substrate (not shown) to form the array. Since the dies 4 are a half wavelength wide, the centre-centre spacings 10 of the transmitters 6 in both X and Y directions are also half a wavelength. It will also be seen that receivers 8 in respective corners of adjacent dies form respective 2×2 mini arrays 12. Due to the size of the dies 4, these mini arrays 12 are also separated by half a wavelength.

Although in FIG. 5 only six dies 4 are shown, in exemplary embodiments there might be many dies in one or both dimensions of the array.

The wavelength λ of sound depends on the velocity of sound c and its frequency f: λ=c/f

For technical usable ultrasound in air (above 40 kHz to ensure it is above the audible range for dogs) the wavelength is below 8.6 mm and half the wavelength, which is an important parameter for ultrasound arrays, is therefore below 4.3 mm. This is a typical dimension of a MEMS (microelectromechanical system) type device such as those described herein.

For typical MEMS type structures such as cantilevers and membranes, the frequency of the fundamental vibration modes can be expressed by the following equations:

Cantilever:

$$f = \frac{1.015}{2 π} \frac{t}{{L}^{2}} \sqrt{\frac{E}{ρ}}$$

Circular membrane/diaphragm:

$$f = \frac{40.8}{2 π} \frac{t}{{d}^{2}} \sqrt{\frac{E}{12 ( 1 - v ) ρ}}$$

Here t is the thickness of the mechanical structure, E the Young's modulus, ρ is the density, L the length of a cantilever and d the diameter of a circular membrane. These equations are for a single material, but can quite easily be modified for a multi-layered structure.

These equations exemplify the feasibility of MEMS ultrasound structures. The eigenfrequency of a 8 μm thick silicon membrane with 1250 μm diameter, which are typical dimensions for MEMS structures, has an eigenfrequency of about 80 kHz.

Most standard beamforming algorithms benefit from λ/2 spacing because it means that each incoming wave front can be discerned from other incoming wavefronts with a different angle or wavenumber, which in turn means that the problem of so-called ‘grating lobes’ is prevented. Classical beamforming methods that benefit from λ/2 (or tighter) spacing include (weighted) delay-and-sum beamformers, adaptive beamformers such as MVDR/Capon, direction-finding methods like MUSIC and ESPRIT and Blind Source Estimation approaches like DUET, as well as wireless communication method, ultrasonic imaging methods with additional constraint such as entropy or information maximization.

FIG. 6 shows a further array 14 made up of a number of dies 4 of the type shown in FIG. 2 attached to a flexible substrate in the form of a ribbon 16 made, for example, of polyurethane. This array 14 can be attached to any number of objects or devices or could form part of a wearable device. FIG. 7 shows one example where the array 14 is attached to the body of an unmanned aerial vehicle or drone 18. In such an arrangement a processor (not shown) driving the transmitters and receivers thereof can be programmed to operate in a calibration phase whereby individual transmitters 6 in the array 14 transmit different signals, or signals at different times, which are them received by receivers 8 on other dies in the array. Using a suitable algorithm, such as transmitting a coded signal (CDMA type) or a chirp signal, followed by matched filtering or deconvolution, and signal peak detection such as i.e. a CFAR filter, the times of flight of such transmissions can be used to establish the relative mutual positions of the individual dies 4. In some situations one is more interested in computing relative time-differences of arrival (TDOA) between two receivers and one transmitted/reflected signal. There is a range of popular methods for this, including Generalized Cross Correlation PHAse Transform (GCC-PHAT) and Steered Response PHAse Transform (SRP-PHAT).

These can then be used during operation to apply appropriate phase differences to the signals of respective receivers to allow them to act as a coherent array—e.g. for beamforming. Such an approach is beneficial in allowing the array to be attached to any number of irregularly shaped objects so that the precise attachment is not critical.

The drone 18 can use the array 14 for echolocation, collision avoidance etc.

FIG. 8 is a schematic diagram of a PMUT 302 and associated system which is able to compensate for direct path signals. The system includes a PMUT 302 which comprises a square silicon die 304 on which a transmitter element 306, and a receiver element 308 are formed.

An ASIC (application-specific integrated circuit) or DSP (digital signal processor) 42 is connected to a primary digital to analogue (D/A) converter 34. This primary D/A converter 34 is connected to an amplifier 132 which drives the ultrasonic transmitter 306. The ultrasonic transmitter 306 thus emits an ultrasonic signal 48.

The ultrasonic receiver 308 receives reflected echoes 50 which are reflected from an object of interest. The ultrasonic receiver 308 also receives acoustic direct path signals 44, 46. One of the direct path signals 44 is an in-air direct acoustic path signal. The other direct path signal 46 is transmitted through the body of the die 304 from the transmitter 306 to the receiver 308. Other transmission mechanisms may contribute to the overall direct path signal received by the receiver 308.

The ASIC/DSP 42 further generates an estimate of the effect of the direct path signals 44, 46 on the received ultrasonic signals as will be described in more detail below with reference to FIG. 9. The ASIC/DSP 42 comprises a signal modifier 52 which may modify the estimate produced. The signal modifier 52 may for example incorporate a filter that applies a convolution to the output signal from the ASIC/DSP 42. The estimated direct path signal passes to a D/A converter 54 which converts it to an analogue signal. This analogue signal passes through an amplifier 36 to a mixer 38. The mixer subtracts the analogue estimated direct path signal from the analogue signal produced by the receiver 308, and the resultant signal is passed to an analogue to digital (A/D) converter 40 to produce a digital signal which may be further analysed e.g. for echolocation, stored etc.

Typically, the direct path signals 44, 46 are much stronger than the received echoes 50. The described embodiment advantageously removes the direct path signals 44, 46 prior to sampling for conversion to digital signals. If the direct path signals 44, 46 were not removed, the A/D converter 40 would require a high dynamic range in order to convert both the received echoes 50 to digital signals, as well as the direct path signals 44, 46. A high dynamic range A/D converter is more complex and thus more expensive and power consuming.

FIG. 9 is a flowchart illustrating a method generating the estimate of the direct path signals 44, 46 in the system shown in FIG. 8. At step 58, the system starts recording the direct path signals 44, 46 from the transmitter element 306 to an individual receiver 308. If there are multiple receivers, as shown in FIG. 2, then the process may be repeated for each individual receiver. The signal recorded does not include reflections from the environment because time-gating is used to exclude these (since they have a longer time of flight than the direct path signals).

Since the direct path signals 44, 46 can vary with conditions, such as temperature, it may be desirable to record several direct path signals 44, 46 over a longer period of time, or over multiple time instances during a day (when the system is not in use) to obtain a sufficient database in step 60. Optionally, the recordings may be used to estimate the direct path signals 44, 46 at different temperatures and pressure levels by resampling at slightly higher or lower frequencies.

At step 62, a criterion for whether a sufficient database of direct path signals has been created is tested. This criterion could be related to any suitable quality parameter such as the degree of self-repetition of the pre-recorded direct path signals i.e. whether the past signals are repeating themselves, or the criterion could be tied to a temperature sensor which requires direct path signals for a certain range of temperatures to have been collected for the database to be “complete”. The database may be updated from time to time as the physical surroundings around the elements may change. For example, the transmitter 306, or receiver 308 may be moved to a different housing, or dust may have fallen on or close to the sensor and affect the direct acoustic paths. If the database quality is not adequate, then further recording of the direct path signals is carried out.

Once the database quality is determined to be adequate, in step 64, a recording session for reflected signals begins. An initial estimate of direct path signals is provided in step 66, either as a random guess, or taking into account input from a temperature sensor (not shown) used in the direct path signal database creation steps 58-62. The D/A converter 54 then converts the estimated direct path signal from the ASIC/DSP 42 so that it can be subtracted in the mixer 38.

In step 70, the transmitter 306 transmits an ultrasound signal, and the receiver 308 receives the reflected echoes 50, and direct path signals 44, 46. In steps 72 and 74, the quality of the received data is monitored to identify whether the selected direct path signal from step 66 was a good selection. An example of a parameter for quality is minimal energy which signals that the strongest component in the received signal (the direct path 44, 46) has been successfully been removed. Alternatively, maximum sparsity may be used as a parameter, as this signals that a “clear echo” is being received. Generally, mixes of echoes 50 and direct path signals 44, 46 tend to be more complex than any one of them separately. Other parameters such as reflecting entropy or self-similarity over time could also be used.

If the quality in step 74 is good, in step 76, the received signal from the mixer 38 passes to the A/D converter 40, and may be used for further analysis such as proximity, presence or gesture sensing.

If the quality in step 74 is poor, and the quality is not below a first threshold in step 78, only minor modifications to the estimate of the direct path signal are necessary. These minor modifications may be incorporated by a filter 52 which applies a convolution to the estimated direct path signal in order to attempt to rectify the estimated direct path signal in step 80.

If the quality parameter is below a second critical threshold, in step 82, the system starts to record direct path signals again, in order to build up a new database. This may be necessary when there is a substantial change in the behaviour or surroundings of the transmitter element 306.

If the quality parameter is below the first threshold, but not below the second threshold, another candidate may be selected for the estimated direct path signal, as shown in step 84.

FIG. 10 is a schematic diagram of another embodiment of a PMUT 302′ and associated system for compensating for direct path signals. This embodiment is almost identical to that of FIG. 8 and similar parts are indicated with similar reference numerals with the addition of a prime symbol. However in this embodiment the PMUT 302′ further includes acoustic path barriers 56. These acoustic path barriers 56 may for example, be a cylinder around the transmitter 306′, a cylinder around the receiver 308′, or a cylinder around both the transmitter 306′ and receiver 308′. The acoustic path barriers 56 act to physically reduce the strength of the in-air direct acoustic path signal 44′ by reducing air transmission of the signal 44′ between the transmitter 306′ and the receiver 308′.

FIG. 11 is a view of a PMUT 402 using optical receivers 408. These could, for example comprises MEMS structures where movement of a membrane by acoustic signals is read out using light reflected from the membrane, e.g. using a diffraction grating. The optical receivers 408 may be much more closely spaced than the receivers 8 shown in FIG. 2, as optical receivers have much lower self-noise and thus much better SNR than conventional receivers. The optical receivers 408 may therefore be much more closely spaced than λ/2, with images still obtained with high resolution. As such, through use of closely spaced optical receivers 408, a compact ultrasound imaging component is formed on a single die 404.

1. A piezoelectric micro-machined ultrasonic transducer (PMUT) comprising a dedicated ultrasonic transmitter and at least one separate dedicated ultrasonic receiver on a single common semiconductor die.

2. A PMUT as claimed in claim 1 wherein the die is square or rectangular.

3. A PMUT as claimed in claim 2 wherein the ultrasonic transmitter is located substantially at the centre of the die and the ultrasonic receiver(s) is/are located substantially in a corner or in respective corners of the die.

4. A PMUT as claimed in claim 3 comprising one ultrasonic receiver in each of the corners of said die.

5. A PMUT as claimed in claim 1 wherein the ultrasonic transmitter has a width that is at least twice as large as a width of the ultrasonic receiver.

6. A PMUT as claimed in claim 1 wherein the ultrasonic transmitter is configured to transmit signals having a main wavelength and said semiconductor die has a width substantially equal to half of said main wavelength.

7. A PMUT as claimed in claim 1 comprising one or more acoustic path barriers arranged between the ultrasonic transmitter and the ultrasonic receiver.

8. An arrangement comprising a plurality of PMUTs as claimed in claim 1 arranged in a tessellated array.

9. An arrangement as claimed in claim 8 wherein said array is a rectangular array.

10. A system for transmitting and receiving ultrasonic signals comprising at least one PMUT as claimed in claim 1, a transmitter circuit arranged to drive said ultrasonic transmitter and a receiver circuit arranged to detect signals from said ultrasonic receiver.

11. A system as claimed in claim 10 arranged to subtract a direct path signal from a received signal to produce a modified received signal.

12. A system as claimed in claim 11 arranged to subtract the direct path signal from an analogue received signal prior to conversion to digital to produce a modified analogue received signal.

13. A system as claimed in claim 10 arranged to transmit a first ultrasonic signal from the dedicated ultrasonic transmitter and arranged to receive a second ultrasonic signal from the dedicated ultrasonic receiver, the system further comprising a signal processing subsystem comprising:
an analogue domain;
a digital domain;
a digital to analogue converter; and
an analogue to digital converter,
wherein the signal processing subsystem is arranged to generate an estimated direct path signal in said digital domain, convert said estimated direct path signal to an analogue estimated direct path signal using said digital to analogue converter, subtract said analogue estimated direct path signal from said second signal to produce a modified received signal and convert said modified received signal to a digital modified received signal using said analogue to digital converter.

14. A system comprising at least one piezoelectric micro-machine ultrasonic transducer (PMUT), the PMUT comprising, on a single common semiconductor die, a dedicated ultrasonic transmitter arranged to transmit a first ultrasonic signal and at least one separate dedicated ultrasonic receiver arranged to receive a second ultrasonic signal, the system further comprising a signal processing subsystem comprising:
an analogue domain;
a digital domain;
a digital to analogue converter; and
an analogue to digital converter,
wherein the signal processing subsystem is arranged to generate an estimated direct path signal in said digital domain, convert said estimated direct path signal to an analogue estimated direct path signal using said digital to analogue converter, subtract said analogue estimated direct path signal from said second signal to produce a modified received signal and convert said modified received signal to a digital modified received signal using said analogue to digital converter.

15. The system as claimed in claim 14 arranged to record the direct path signal from the transmitter to the receiver to create a database of direct path signals.

16. The system as claimed in claim 15 arranged to choose the estimated direct path signal from the database.

17. The system as claimed in claim 16 arranged to monitor a quality parameter of the digital modified received signal and, based on the quality parameter, to carry out one of:
using the estimated direct path signal; modifying the estimated direct path signal; choosing a new estimated direct path signal from the database; or recording one or more new direct path signals from the ultrasonic transmitter to the ultrasonic receiver.

18. A method of operating a system for transmitting and receiving ultrasonic signals as claimed in claim 14, the method comprising transmitting signals from said ultrasonic transmitter and receiving signals using said ultrasonic receiver at the same time for at least part of a period of operation.

19. A method of operating a system for transmitting and receiving ultrasonic signals as claimed in claim 14, the method comprising transmitting signals from said ultrasonic transmitter having a main wavelength which is substantially twice a width of said semiconductor die.

20. A method of operating a system for transmitting and receiving ultrasonic signals as claimed in claim 14, the method comprising periodically transmitting signals from said ultrasonic transmitter wherein each transmission period is longer than 0.1 millisecond.

21. A method of operating a system for transmitting and receiving ultrasonic signals comprising a non-planar array of piezoelectric micro-machined ultrasonic transducers (PMUTs), each comprising a dedicated ultrasonic transmitter and at least one separate dedicated ultrasonic receiver on a single common semiconductor die, the method comprising transmitting one or more signals from the transmitter of at a first one of said PMUTs in said non-planar array, receiving said signal(s) using at least one receiver of a second one of said PMUTs of said non-planar array and using said received signals to determine a mutual relative position of said first and second PMUTs.

22. A method as claimed in claim 21 comprising using the mutual relative position in subsequent signal processing of signals received by one or more receivers on said first and second PMUTs.

23. A system for transmitting and receiving ultrasonic signals comprising a non-planar array of piezoelectric micro-machined ultrasonic transducers (PMUTs), each comprising a dedicated ultrasonic transmitter and at least one separate dedicated ultrasonic receiver on a single common semiconductor die, the system being configured to carry out the method of claim 21.
